(19) United States
(12) Patent Application Publication
(10) Pub. No.: US 2021/0146992 A1
(43) Pub. Date: May 20, 2021

(54) Steering System Having an Electromechanical Steering Actuator and Method for Equipping a Vehicle and Vehicle Therewith

(71) Applicant: R.H. Sheppard Co. Inc., Hanover, PA (US)

(72) Inventors: Thomas Dieckmann, Pattensen (DE); Jan Reiners, Hannover (DE)

(21) Appl. No.: 16/953,453

(22) Filed: Nov. 20, 2020

(30) Foreign Application Priority Data
Nov. 20, 2019 (DE) 10 2019 131 298.1

(51) Int. Cl. B62D 5/04; B62D 7/18; B62D 7/16

(52) U.S. Cl. CPC B62D 5/0421; B62D 5/0403; B62D 7/16; B62D 7/18

(57) ABSTRACT

A steering system (11) for a vehicle (10) includes an electromechanical steering actuator (46) and a steering linkage (37) movable depending on the steering actuator (46). The linkage (37) includes a steering rod (30) adapted to be connected in an articulated manner to the steering knuckle (22) or an articulated lever (24) of the steering knuckle (22) for moving the steering knuckle (22). The linkage (37) further comprises a bell crank (35) having a first end area (39) connected in an articulated manner to the steering rod (30) and a second end area (40) connected in an articulated manner to a vehicle frame (12) of the vehicle (10) or to the steering actuator (46). A point of application (63) of the steering actuator (46) on the steering linkage (37) is spaced apart from the second end area (40) of the bell crank (38).

### BACKGROUND OF THE INVENTION

The invention relates to the steering of vehicles, in particular commercial vehicles such as trucks, buses and the like. In such vehicles, wheels of a front axle are usually coupled via a steering gear to a steering column and a steering wheel in order to be steered by a driver as a function of a rotational movement of the steering wheel.

According to the prior art, steering systems are known in which a rotational movement of the steering column is supported by hydraulic amplification. The rotary motion is usually performed by a driver by means of a steering wheel, wherein the execution of the rotary motion is facilitated thanks to the support for the driver. In these steering systems, the rotation mechanically opens and closes hydraulic valves to provide an additional force to adjust a wheel steering angle of the wheels by means of a pressurized fluid. Overall, this increases the driver's comfort. Such a steering system can also be called a hydraulic steering system.

Due to increasing automation in the field of vehicle control and the associated desire for automated actuation of steering systems, the desire for an electrical interface to control the steering, systems is growing. Therefore, solutions are already known in which the above-mentioned hydraulic valves are not actuated in mechanical dependence on the rotary motion of a steering column, but in dependence on electromechanical actuators. On the one hand, the electromechanical actuators can be controlled by sensors which are arranged on the steering column and detect a rotary motion, thus switching the hydraulic valves in a functionally similar way. At the same time, when using electromechanical actuators, it is also possible to control the electromechanical actuators by electronic components, such as a control unit, independently of a rotary movement of the steering column. For example, the control unit generates a steering request by a driver assistance system. In addition, the electromechanical actuators mentioned above can be designed in such a way that, e.g. in case of a failure of the hydraulic circuit, an electromechanical drive of the steering gear is possible in addition to the actuation of the valves. However, such solutions are very complex in design and can therefore only be realized under consideration of high costs.

For this reason, it is further known that steering systems are no longer supported by hydraulic steering actuators, but purely electromechanical steering actuators are used instead. A combination of hydraulics and electric systems is no longer necessary. Nevertheless, such electric steering systems have hardly been used so far, as they are difficult to integrate into existing systems. The reason for this is that installation space and length in the vehicle are very limited, hut an electromechanical steering actuator of an electric steering system is usually designed in a relatively elongated manner compared to an actuator of a hydraulic steering system.

In particular in previous solutions using an electric steering actuator, a steering rod is therefore significantly shortened in order to comply with the installation space and installation length and to provide sufficient actuation movement for the electric steering actuator. This is particularly true it an electric steering system is to be used in a vehicle that is dimensioned and designed for a hydraulic steering system.

However, the length of the steering rod is an essential parameter within the steering kinematics. The reason for this is that the wheels of the steerable axle also move relative Lo the vehicle frame in a spring-damper system. This means that the rolling and pitching movements of the vehicle are convened into steering movements to a greater extent when the steering rods are shortened and are thus coupled into the steering behavior as disturbances.

It is therefore the task of the present invention to find an electric steering system in which the problems of the prior an are eliminated or minimized. In particular, the coupling of movements, especially rolling and pitching movements, of the vehicle into steering movements shall be minimized or at least reduced. In an case, an alternative steering system to previously known steering systems shall be found.

### SUMMARY OF THE INVENTION

For this purpose, the invention relates to a steering system according to claim 1, a vehicle having such a steering system according to claim 10, and a method for equipping a vehicle with a steering system according to claim 14.

The invention relates firstly to a steering system for a vehicle, in particular a commercial vehicle. The steering system comprises an electromechanical steering actuator and a steering linkage which can be moved depending on the steering actuator. The steering linkage has a steering rod. The steering rod is adapted to be articulated to the steering knuckle or an articulated lever of the steering knuckle for moving at least one steering knuckle of the vehicle. Furthermore, the steering linkage has a boil crank which comprises two end areas opposite each other in a longitudinal direction of the bell crank. In a first end area, the bell crank is articulated to the steering rod, and in a second end area the bell crank is designed to be articulated to the vehicle frame or the steering actuator. A connection of the second end area of the bell crank to the steering actuator also especially comprises a connection of the second end area of the bell crank with a housing of the steering actuator. A joint for the articulated connection of the bell crank with the steering actuator is therefore preferably integrated in or on a housing of the steering actuator.

The steering rod therefore also has two opposite end areas in then longitudinal direction, with one end area being connected to the bell crank and the other end area being designed to be articulated to the steering knuckle or the articulated lever. Furthermore, a point of application of the steering actuator is located on or at the steering linkage, in particular for transmitting a force of the steering actuator to the steering linkage, at a distance from the second end area of the bell crank. The point of application preferably designates a point or area in which the steering actuator is connected to the steering linkage for the transmission of force. This can also be referred as a coupling point, connecting point or attachment point. In this case, spaced refers to a predetermined distance, which in any case is greater than zero. Preferably, the point of application of the steering actuator is at least one bell crank length of the bell crank in the longitudinal direction of the bell crank remote from the area or point of the bell crank to which the bell crank is or can be connected on the vehicle.

By providing a bell crank connected between the frame and the steering rod, the steering rod is still carried along by the bell crank in case of rolling and pitching movements of the vehicle. A steering actuator must therefore only partially follow these movements, as these movements can be split between the bell crank and the steering actuator. This means that the steering actuator can be positioned essentially freely in the vehicle and has to be arranged such a way that it leads to a movement of the steering rod when a steering request is made. This makes it possible to maintain a length of a steering, rod that is dimensioned for the vehicle if it were equipped with a conventional hydraulic steering system.

An electromechanical steeling actuator can thus be used without the rolling and pitching movements of the vehicle causing significant disturbance to the steering.

According to a first embodiment, the steering actuator is articulated to the steering rod. Preferably, this connection between steering actuator and steering rod is provided in a central area of the steering rod. If, for example, the steering rod is divided into three parts of equal length in its longitudinal direction, the central area corresponds to the middle of the three parts.

This connection enables the steering actuator to exert a force on the steering rod and thus steer the steering knuckle and the wheel connected to it, while the steering rod continues to be carried by the bell crank. The articulated connection between the steering actuator and the steering rod allows the steering rod to move relative to the steering actuator in the event of occurring vehicle movements, such as rolling movements. These relative movements are not transmitted to the steering actuator, at least in the degrees of freedom in which the articulated connection is pivotable, so that the steering actuator is also at least partially decoupled. In addition, an elongated steering, actuator can also be used, since the steering actuator and the steering rod can be arranged at least partially essentially parallel to each other in aa longitudinal direction of the vehicle up to a coupling point between the steering actuator and the steering rod. Thus, a sufficient length of a movement in one actuation direction of the steering actuator may be provided, which allows the axle to be turned in sufficiently far to allow for the intended turning circle of the vehicle.

According to another embodiment, the bell crank is a first bell crank. Furthermore, the steering system comprises a coupling rod and a second bell crank. The second bell crank is arranged, especially in an end area of the second bell crank or a central area of the second bell crank, to be articulated to the vehicle, especially the vehicle frame of the vehicle. The second bell crank is further articulated to a first end area of the coupling rod and the coupling rod with its second end area is articulated to the first bell crank. Furthermore, the steering actuator is further articulated to the coupling rod or one of the bell cranks, especially the second bell crank.

According to this, two bell cranks are connected to the vehicle frame in an articulated mariner and these in turn are connected to each other, especially at a distance from the vehicle frame, with a coupling rod. The coupling rod is preferably arranged essentially parallel to a plane formed by the vehicle frame. The two bell cranks are preferably connected by the coupling rod in such a way that a movement of one bell crank is translated via the coupling rod into a movement of the other bell crank. Accordingly, if the steering actuator is connected to the second bell crank, a movement performed by the steering actuator is transmitted via the coupling rod to the first bell crank, which then moves the steering roil to steer the steering knuckle. In this way, the steering actuator and the steering rod can essentially be arranged in an overlapping manner or in the same longitudinal section of a vehicle, thus allowing for a particularly economical installation space. At the same time, a satisfactory decoupling of the rolling and pitching movements of the steering linkage, which corresponds to the prior art, is achieved.

According to a first special embodiment of the previous embodiment, the second bell crank is designed to be articulated to the vehicle, especially the vehicle frame, in a first end area of the second bell crank. In an opposite second end area of the second bell crank, the steering actuator is then articulated to the second bell crank. The coupling rod is also articulated to the second bell crank in the second end area or in a central area of the second bell crank.

According to a second special embodiment, the second bell crank is again adapted to be articulated to the vehicle, in particular the vehicle frame in a first end area of the second bell crank. In the central area of the second bell crank, the steering actuator is then articulated to the second bell crank. The coupling rod is also connected to the second bell crank in the central area or in the second end area of the bell crank.

According to a third special embodiment, the second bell crank is arranged to be connected to the vehicle, especially the vehicle frame, in the central area of the second bell crank. In the first end area of the second bell crank, the steering actuator is then articulated to the second bell crank. The coupling rod with the second bell crank is then articulated to the second bell crank in the second end area of the bell crank.

According to this third special embodiment, the steering system is preferably designed so that the first end area of the second bell crank is at or above the level of the vehicle frame after the second bell crank is connected to the vehicle frame, whereas the second end area is below the vehicle frame. In particular, the steering actuator in this latter case is also adapted in such a way that it can be connected to the vehicle frame at the level of or above the vehicle frame.

To define and delimit the areas of the second bell crank, for example, a length of the second bell crank in longitudinal direction is assumed and the second bell crank is divided into three parts of equal length along this length. Two of the three parts are adjacent to one end of the second bell crank. One of these two parts is defined as the first end area and the other of these parts is defined as the second end area. The part in between then corresponds to the central area.

According to a further embodiment, the steering actuator is designed to be articulated, in particular by means of a first pivot joint, to the vehicle, in particular the vehicle frame. The steering actuator is thus pivotable and can follow a movement which is e.g. predetermined by the two bell cranks and the coupling rod and does not correspond to the actuation direction. A pivot joint describes a joint that only allows movement in one degree of freedom. The movement or rotational movement along this degree of freedom can also be called pivoting movement. According to a special embodiment, the joint, in particular the pivot joint, with which the steering actuator can be connected to the vehicle, comprises a rotation axis around which a joint can also be rotated, with which the first bell crank can be connected to the vehicle.

According to another embodiment, to first bell crank and the second bell crank are each designed to be connected to the vehicle frame in an articulated manner by means of a second pivot joint and a third pivot joint respectively. The coupling rod is also connected in its first end area to the second bell crank via a fourth pivot joint and in its second end area to the first bell crank via a fifth pivot joint. This allows the steering actuator to also only have to pivot in one degree of freedom and all other degrees of freedom can be blocked, for example by the aforementioned first pivot joint between the steering actuator and the vehicle. A robust arrangement of the steering actuator on the vehicle, especially on the vehicle frame, is thus possible.

This more robust arrangement is due to the fact that a ball joint instead of a pivot joint, if this is used to connect the steering actuator to the vehicle, must be locked in one degree of freedom to prevent the steering actuator from rotating around its longitudinal axis. However, such a locking of a degree of freedom can only be realized by a complex design, since otherwise friction can occur during the movement of the ball joint in the area of the locking, which can lead to wear of the locking or the joint. If a lock is not implemented, there is a risk that the aforementioned torsion of the steering actuator will be transferred to a steering column connected to the steering actuator, thus exerting transverse forces on the joint which contribute to damage and increased wear of this joint.

In particular, any movement of the steering rod or the steering knuckles relative to the vehicle frame is thus completely decoupled from the steering actuator, and the steering actuator only needs to pivoted if it itself moves along an actuation direction or executes a movement.

According to another embodiment, the steering rods are connected to the first bell crank by a first ball joint. The steering rod can also be connected to the steering knuckle or an articulated lever of the steering knuckle in an articulated manner via a second ball joint. Relative movements of the steering knuckle in relation to the vehicle frame are thus not converted into steering movements by the first bell crank, so that disturbances caused by rolling and pitching movements in the steering system are avoided or reduced. The term ball joint is used here as a synonym for a joint that can move in at least two degrees of freedom. The term ball joint is not limited to the use of a ball joint which is generally understood by the term, but a ball joint according to this definition can also be realized for example by two pivot joints arranged perpendicular to each other.

According to another embodiment, the steering rod has a length that is at least twice as long, preferably at least three times or especially preferably at least four times, the length of a bell crank of the first bell crank.

Preferably, the length of the bell crank is essentially the same as that of a steering column lever of a conventional hydraulic steering system, dimensioned for the vehicle on which the electric steeling system is to be used. Accordingly, in the case of a conventional hydraulic steering system, a length of a steering column lever is provided for conventional vehicles and, if the steering system according to the invention is to be used for this vehicle, the length of the ball crank preferably corresponds to the length of this steering column lever. Preferably, the steering rod also corresponds to a length of a steering rod dimensioned for the vehicle with a conventional hydraulic steering system.

This means that even a vehicle for which a conventional hydraulic steering system has so far been dimensioned can be fitted with the steering system according to the invention in this way without changing the driving behavior of the vehicle. Driver assistance systems can thus continue to operate without adaptation.

According to another embodiment, the first bell crank is adapted to establish the articulated connection with the vehicle frame via the second pivot joint. Especially in the case where the steering actuator is direct iv connected to the coupling rod or the bell crank, such a steering behavior of the vehicle is identical to the steering behavior of a vehicle conventional hydraulic steering system. The bell crank, which preferably replaces the steering column lever of a conventional hydraulic steering system, can only be pivoted in one degree of freedom, i.e. around one axis, similar to the steering column lever.

According to another embodiment, the electromechanical steering actuator is an electromechanical linear actuator, especially with a spindle drive. Such a steering actuator is preferably used, in particular with the combination of a bell crank connected to the steering rod to provide on the one hand a sufficient force to move the axis and on the other hand a sufficient length of travel or length of movement along an actuation direction.

The invention further comprises a vehicle having a steering system according to one of the aforementioned embodiments. In this case, the steering rod is connected to at least one sleeting knuckle or an articulated lever of the steering knuckle of the vehicle. Furthermore, the first bell crank is articulated to the vehicle, in particular to a vehicle frame.

According to another embodiment, the vehicle has a vehicle frame, wherein the vehicle frame of the vehicle has a mounting position for a steering gear or a steering column lever of a hydraulic steering system. The first bell crank is also articulated to the vehicle at or in the area of this mounting position of the vehicle frame. This means that the vehicle frame provides a mounting position which is defined for the vehicle and a later desired driving behavior. At this mounting position, an arrangement of the steering gear or a steering column lever of a hydraulic steering, system connected to the steering gear is provided. However, instead of a hydraulic steering system, the invention states that the first bell crank is connected to the vehicle frame at this position. This allows the steering system according to the invention to be integrated into the vehicle in such a way that the driving behavior remains unchanged compared to a conventional steering system and at the same time the advantages of a purely electric steering system are made possible.

According to another embodiment, to steering actuator is connected to the vehicle frame by means of the first pivot joint. Accordingly, the steering actuator can be pivot about an axis, i.e. in one degree of freedom. Especially in the case that the steering actuator is a linear actuator, the steering actuator can thus follow a guide which is given to a drive rod or piston of the steering actuator by the moved bell crank, coupling rod or steering rod.

According to another embodiment, the vehicle frame has the mounting position for a steering gear or steering column lever of a hydraulic steering system, wherein the steering actuator is arranged in the longitudinal direction of the vehicle frame at a position further towards a front of the vehicle than the mounting position. This provides sufficient freedom of movement for the steering actuator.

Furthermore, the invention relates to a method for equipping a vehicle, in particular a commercial vehicle, with a steering system according to one of the aforementioned embodiments. Here, first of all an attachment position, in particular for a steering gear or a steering column level of a hydraulic steering system, is identified and at the attachment position or in the area of the attachment position the first bell crank is articulated to the vehicle frame.

Despite the use of a steering system with an electromechanical steering actuator, this allows the vehicle's behavior, especially with regard to steering behavior, to be maintained compared to the use of a conventional hydraulic steering system.

According to a further embodiment of the method, the steering actuator is articulated to the vehicle frame in the longitudinal direction of the vehicle frame further towards the front of the vehicle than the mounting position. The steering actuator is also connected to the second bell crank or coupling rod in an articulated manner, in particular by means of a sixth pivot joint. Alternatively, the steeling actuator is connected to the steering rod in an articulated manner, in particular by a third ball joint.

### BRIEF DESCRIPTION OF THE DRAWINGS

Further embodiments result from the exemplary embodiments explained in detail in the figures.

FIG. 1 shows a first exemplary embodiment of the steering system integrated in a vehicle.

FIG. 2 shows another exemplary embodiment of the steering system.

FIG. 3 shows another exemplary embodiment of the steering system.

FIG. 4 shows a top view of an exemplary embodiment of the steering system.

FIG. 5 shows a hydraulic steering system according to the prior art.

FIG. 6 shows the steering system from FIG. 5 in top view.

FIG. 7 shows the steps of the method according to an exemplary embodiment.

### DETAILED DESCRIPTION OF THE INVENTION

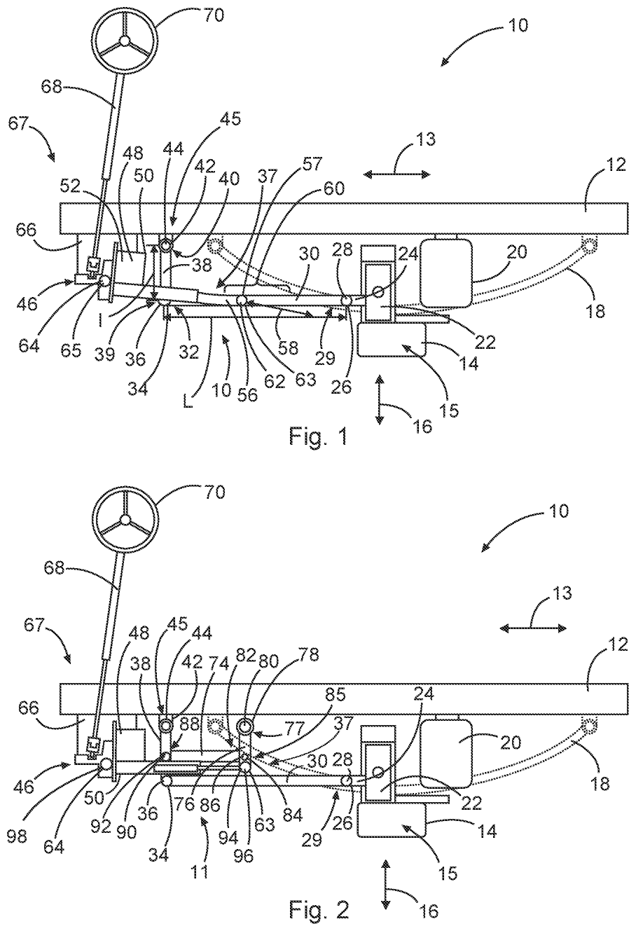

FIG. 1 shows a vehicle 10 in a side view, which has a steering system 11 and a vehicle frame 12, from which other components of the vehicle are suspended in addition to the components shown and which represents the basic structure of the vehicle. The vehicle frame 12 is also known as the chassis. The vehicle frame 12 extends along a longitudinal direction 13 of the vehicle 10.

On vehicle frame 12, an axle 14 is connected at one end to vehicle frame 12 via a joint not shown. The end 15 of the axle 14, visible here in side view, is thus mounted so that it can move in a vertical direction 16 relative to the vehicle frame 12. The shown end 15 of the axle 14 is supported by a leaf spring 18 or an air spring 20. On the axle 14, a steering knuckle 22 is connected to a pivot bearing, which can be rotated around an axle that runs in the vertical direction 16. A wheel (not shown) of a front axle of the vehicle 10 can be attached to the steering knuckle 22. An articulated lever 24 is firmly connected to the steering knuckle 22.

The articulated lever 24 is connected to an end area 29 of a steering rod 30 via a joint 26, which is a second ball joint 28. In its opposite end area 32, the steering rod 30 is connected to a fist bell crank 38 via a further joint 34, Which is a first ball joint 36 in an articulated manner. The steering rod 30 has a length L that is more than twice as long as a bell crank length l of bell crank 38. Steering rod 30 and first bell crank 38 are part of a steering linkage 37.

The first bell crank 38 is connected to the vehicle frame 12 opposite the end area 39 of the bell crank, which is also called first end area 39 of the bell crank 38 and at which the bell crank 38 is connected to the steering rod 30, in another end area 40 of the bell crank 38, which is also called second end area 40 of the bell crank 38, via another joint 42, which is a second pivot joint 44. The position at which the bell crank 38 is articulated to the vehicle triune corresponds to a mounting position 45 for a steering gear or steering column lever of a hydraulic steering system which, however, is not used here in particular.

Furthermore, an electromechanical steering actuator 46 is pro died, which is a linear actuator 48, in particular a spindle drive 50. The steering actuator 46 comprises an electric motor 52, which drives a spindle 54, which is connected to a piston 56 and moves it along an actuation direction 58. A coupling point 62 is provided on the steering rod 30 in a central area 60, to which the piston 56 is connected via a third ball joint 57. The coupling point 62 corresponds to a point of application 63 of the steering actuator 46 on the steering rod 30 of the steering linkage 37, i.e. a point at which the steering actuator 46 transmits a force to the steering linkage 37. The point of application 63 is therefore spaced from the second end area 40 of the bell crank 38. Furthermore, the steering actuator 46 is connected at the other end to a mounting plate 66 on the vehicle frame 12 via a joint 64, which is a fourth ball joint 65. The mounting plate 66 is located further to the front of the vehicle 67 than mounting position 45.

Furthermore, a steering column 68 and a steering wheel 70 are also provided. A rotational movement of the steering wheel 70 is transmitted to the actuator 46 via the steering column 68 and this rotational movement is converted into a movement in the actuation direction 58. This moves the steering rod 30 so that steering the steering knuckle 22 is possible.

FIG. 2 shows an alternative exemplary embodiment where the steering actuator 46 is not directly connected to the steering rod 30. Rather, a coupling rod 74 and a second bell crank 76 are provided in addition tri the first bell crank 38. The second bell crank 76 and the coupling rod 74 are also part of the steering linkage 37. The electric actuator 46 is here connected to the second bell crank 76.

In detail, the second bell crank 76 is connected to the vehicle frame 12 at a first end area 77 via a joint 78, which is a third pivot joint 80. Furthermore, the coupling rod 74 is connected in a first end area 82 of the coupling rod 74 via a joint 84, which is a fourth pivot joint 86, to the second bell crank 76 in the second end area 85 of the second bell crank 76. On the other hand, the coupling rod 74 is connected to the first bell crank 38 in a second end area 88 of the coupling rod 74 via a joint 90, which is a fifth pivot joint 92. The remaining connections between the first bell crank 38 and the steering rod 30 and the steering rod 30 with the articulated lever 24 are identical to FIG. 1.

However, the steering actuator 46 is non connected here via a joint 94, which is a sixth on joint 96, to the second end area 85 of the second bell crank 76. This decouples movements of the axle 14 from the actuator 46 to such an extent that the joint 64, by means of which the actuator 46 is connected to the vehicle frame 12, is designed here as the first pivot joint 98. Essentially, the piston 56 thus moves along the actuation direction 58 almost parallel to the vehicle frame 12.

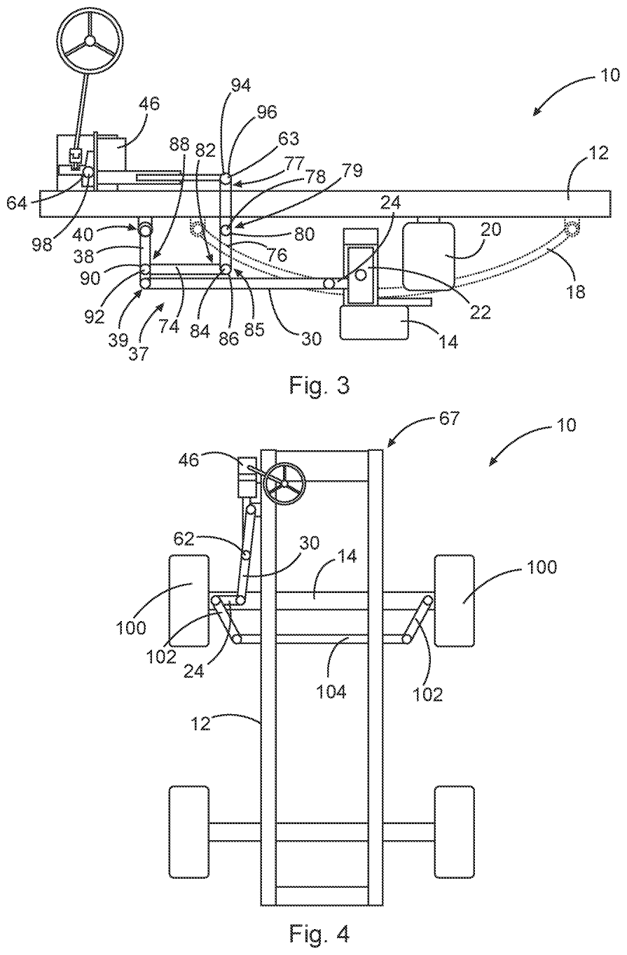

FIG. 3 shows another alternative exemplary embodiment, in which the steering actuator 46 is also not directly connected to the steering rod 30 as in the exemplary embodiment of FIG. 1. Here, as in FIG. 2, the steering linkage 37 comprises the first bell crank 38, the second bell crank 76, the coupling rod 74 and the steering rod 30. The electric drive 46 is connected to the second bell crank 76. Accordingly, the exemplary embodiment in FIG. 3 is similar to the exemplary embodiment in FIG. 2.

In contrast to FIG. 2, however, in FIG. 3 the second bell crank 76 is connected to the vehicle frame 12 in a central area 79 of the second bell crank 76 via a joint which corresponds to the third pivot joint 80. Furthermore, in FIG. 3, the steering actuator 46 is now connected to the first end area 77 of the second bell crank 76 via a joint 94 corresponding to the sixth pivot joint 96.

Steering actuator 46 and the first end area 77 of the second bell crank 46 now lie in or above a plane described by the vehicle frame 12. The second bell crank 76 non exerts a force on the second bell crank is the point of application 63, depending on a force applied by the steeling actuator 46, so that the second bell crank rotates around the pivot point of the third pivot joint 80 and transmits its movement via the coupling rod 74 to the first bell crank 38 and then to the steering rod 30. Here, too, the point of application 63 is therefore at a distance from the second end area 40 of the first bell crank 38.

As in FIG. 2, also in FIG. 3 the coupling rod 74 in the first end area 82 of the coupling rod 74 is connected to the second bell crank 76 in the second end area 85 of the second bell crank 76 via a joint 84, which corresponds to the fourth pivot joint 86. Furthermore, the coupling rod 74 is connected in the end area 88 of the coupling rod 74 to the first bell crank 38 via a joint 90, which is a fifth pivot joint 92. The remaining connections between the first bell crank 38 and the steering rod 30 as well as the steering rod 30 and the articulated lever 24 are identical to FIGS. 1 and 2.

FIG. 4 shows a top view of the vehicle 10 with the steering system 11 according to the exemplary embodiment of FIG. 1. Identical reference numerals correspond to identical features. Accordingly the steering actuator 46 can be recognized, which is connected to the steering rod 30 in a central area 60 of the steering rod 30 in a coupling point 62. Furthermore, the steering rod 30 is connected to the first bell crank 38 in an articulated manner and at a distance from the vehicle frame 12. The steering rod 30 is connected to an articulated lever 24 in order to steer one wheel 100. The steering movement of one wheel 100 is transmitted to another wheel 100 of the same axle via knuckle arm 102 and a track rod 104.

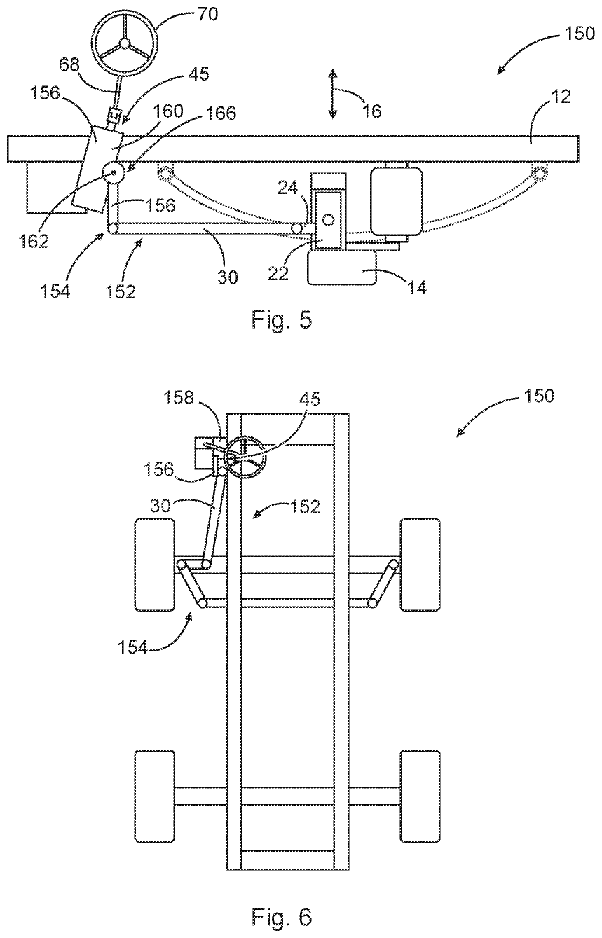

FIGS. 5 and 6 show the prior art in each case with a vehicle 150, which has a hydraulic steering system 152. On one axle 14 of the vehicle 150, a steering knuckle 22 is connected to a pivot bearing, which can be rotated about an axis extending in the vertical direction 16. An articulated lever 24 is firmly connected to the steering knuckle 22. The hydraulic steering system 152 has a steering linkage 154 which comprises a steering rod 30. The articulated lever 24 is connected to the steering rod 30 via a joint 26. The steering rod 30 is in turn connected to a steering column lever 156 which is connected to a steering actuator 158. The steering actuator 158 comprises a sleeting gear 160, wherein the steering gear 160 is connected to the vehicle frame 12 of the vehicle 150 at a mounting position 45. A rotary motion of the steering wheel 70 is transmitted to the steering actuator 158 via the steering column 68 and this rotary motion is converted into a rotary motion about an axis 162 extending perpendicularly to the image plane. A force of the steering actuator 158 is thus transmitted to the steering linkage 154 in or at a point of application 164, with the point of application 164 being located at the end 166 of the steering column lever 156, so that the latter pivots about the axis 162 by the force of the steering actuator 158 and thus moves the steering column 30.

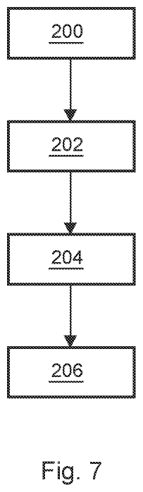

FIG. 7 shows the steps of the method for equipping a vehicle 10 with the steering system 11. In a step 200, a mounting position 45 for a steeling, gear or a steering column lever on the vehicle frame 12 is identified. In step 202, the first bell crank 38 is then connected to the vehicle frame 12 at mounting position 45 or in the area of mounting position 45 in an articulated manner.

In step 204, a steering actuator 46 is articulated to the vehicle frame 12, wherein preferably this connection is carried out further towards a vehicle front 67 than the mounting position 45. In a step 206, the steering actuator 46 is then connected in an articulated manner, in particular by means of a sixth pivot joint 96, to the second bell crank 76 or the coupling rod 74, or in an articulated manner, in particular by means of a third ball joint 57, to the steering rod 30.

### LIST OF REFERENCE NUMERALS (PART OF THE DESCRIPTION)

### 10 Vehicle

11 Steering system
12 Vehicle frame
13 Longitudinal direction

### 14 Axle

15 End of the axle
16 Vertical direction
18 Leaf spring

### 20 Air Spring

22 Steering knuckle
24 Articulated lever

### 26 Joint

28 Second ball joint
32 End area

### 30 Steering rod

32 End area
34 Further joint
36 First ball joint
37 Steering linkage
38 First bell crank
39 End area
40 End area
42 Further joint
44 Second pivot joint
45 Mounting position
46 Electromechanical steering actuator
48 Linear actuator
50 Spindle drive

### 52 Motor

### 54 Spindle

### 56 Piston

57 Third ball joint
58 Actuation direction
60 Central area
62 Coupling point

### 64 Joint

65 Fourth ball joint
66 Mounting plate
67 Front side of vehicle
68 Steering column
70 Steering wheel

### 74 Coupling rod

76 Second bell crank
77 First end area

### 78 Joint

79 Central area
80 Third pivot joint
82 First end area

### 84 Joint

85 Second end area
86 Fourth pivot joint

### 88 Second end

### 90 Joint

92 Fifth pivot joint

### 94 Joint

96 Sixth pivot joint
98 First pivot joint

### 100 Wheel

### 102 Knuckle arm

### 104 Track rod

### 150 Vehicle

152 Hydraulic steering system
154 Steering linkage
156 Steering column lever
158 Steering actuator
160 Steering gear

### 162 Axis

164 Point of application
166 End of the steering column lever

### 200 Step

### 202 Step

### 204 Step

### 206 Step

1. A steering system (11) for a vehicle (10), comprising:
an electromechanical steering actuator (46); and
a steering linkage (37) which can be moved as a function of the steering actuator (46) and comprises
a steering rod (30), wherein the steering rod (30) is adapted to be connected in an articulated manner to a steering knuckle (22) or to an articulated lever (24) of the steering knuckle (22) in order to move the steering knuckle (22) of the vehicle (10);
a first bell crank (38) which is connected in an articulated manner to the steering rod (30) in a first end area (39) of the first bell crank (38) and is adapted in a second end area (40) of the first bell crank (38) to be connected in an articulated manner to a vehicle frame (12) of the vehicle (10) or to the steering actuator (46),
wherein a point of application (63) of the steering actuator (46) on the steering linkage (37) lies spaced apart from the second end area (40) of the first bell crank (38).

2. The steering system (11) according to claim 1, wherein the steering actuator (46) is connected in an articulated manner to the steering rod (30) in a central area (60) of the steering rod (30).

3. The sleeting system (11) according to claim 1, wherein the steering linkage (37) further comprises a coupling rod (74) and a second bell crank (76), wherein the second bell crank (76) is adapted in a first end area (77) of the second bell crank (76) or a central region (79) of the second bell crank (76) to be connected in an articulated manner to the vehicle frame (12) of the vehicle (10) or to the steering actuator (46), the second bell crank (76) is connected in an articulated manner to a first end area (82) of the coupling rod (74) and the coupling rod (74) is connected in an articulated manner in its second end area (88) to the first bell crank (38), wherein the steering actuator (46) is connected in an articulated manner to the coupling rod (74) or to the second bell crank (76).

4. The steering system (11) according to claim 3, wherein the steering actuator (46) is adapted to be connected in an articulated manner to the vehicle frame (12) of the vehicle (10) by means of a first pivot joint (98).

5. The steering system (11) according to claim 3, wherein the first bell crank (38) is adapted to be connected to the vehicle frame (12) of the vehicle (10) or the steering actuator (46) by means of a second pivot joint (44), and the second bell crank (76) is adapted to be connected to the vehicle frame (12) of the vehicle (10) or the steering actuator (46) by means of a third pivot joint (80), and wherein the coupling rod (74) is connected in the first end area (82) of the coupling rod (74) via a fourth pivot joint (86) to the second bell crank (76) and in the second end area (88) of the coupling rod (74) via a fifth pivot joint (92) to the first bell crank (38).

6. The steering system (11) according to claim 1, wherein the steering rod (30) is connected in an articulated manner to the first bell crank (38) via a first ball joint (36) and is adapted to be connected in an articulated manner to the steering knuckle (22) or an articulated lever (24) of the steering knuckle (22) via a second ball joint (28).

7. The steering system (11) according to claim 1, wherein the steering rod (30) has a length (L) which is at least twice as long as a bell crank length (l) of the first bell crank (38).

8. The steering system (11) according to claim 1, wherein the first bell crank (38) is adapted to be connected in an articulated manner to the vehicle frame (12) via a second pivot joint (44).

9. The steering system (11) according to claim 1, wherein the electromechanical steering actuator (46) is an electrical linear actuator (48) with a spindle drive (50).

10. A vehicle (10), comprising:
a steering knuckle (22); and,
a steeling system (11) including
an electromechanical steering actuator (46); and
a steering linkage (37) which can be moved as a function of the steering actuator (46) and comprises
a steering rod (30), wherein the steering rod (30) is adapted to be connected in an articulated manner to a steering knuckle (22) or to an articulated lever (24) of the steering knuckle (22) in order to move the steering knuckle (22) of the vehicle (10),
a first bell crank (38) which is connected in an articulated manner to the steering rod (30) in a first end area (39) of the first bell crank (38) and is adapted in a second end area (40) of the first bell crank (38) to be connected in an articulated manner to a vehicle frame (12) of the vehicle (10) or to the steering actuator (46),
wherein a point of application (63) of the steering actuator (46) on the steering linkage (37) lies spaced apart from the second end area (40) of the first bell crank (38).

11. The vehicle according to claim 10, wherein the vehicle frame (12) of the vehicle (10) has a mounting position (45) for a steering gear (160) or a steering column lever (156) of a hydraulic steering system (152) and the first bell crank (38) on the vehicle (10) is connected in an articulated manner to the vehicle frame (12) of the vehicle (10) or the steering actuator (46) at or in the region of the mounting position (45) of the vehicle frame (12).

12. The vehicle according to claim 10 wherein the steering actuator (46) is connected to the vehicle frame (10) of the vehicle by means of the first pivot joint (98).

13. The vehicle (10) according to claim 10 wherein the vehicle frame (12) of the vehicle (10) has a mounting position (45) for a steering gear (160) or a steering column lever (156) of a hydraulic steering system (152) and the steering actuator (46) is arranged in the longitudinal direction (13) of a vehicle frame (12) pf the vehicle (10) in the direction of a vehicle front side (67) in front of the mounting position (45) for a steering gear (160) or a steering column lever (156) of a hydraulic steering system (152).

14. A method for equipping a vehicle (10) with a steering system (11) including an electromechanical steering actuator (46) and a steering linkage (37) which can be moved as a function of the steering actuator (46), the steering linkage (37) comprising a steering rod (30), wherein the steering rod (30) is adapted to be connected in an articulated manner to a steering knuckle (22) or to an articulated lever (24) of the steering knuckle (22) in order to move the steering knuckle (22) of the vehicle (10), and a first bell crank (38) which is connected in an articulated manner to the steering rod (30) in a first end area (39) of the first bell crank (38), the method comprising the steps of:
identifying (20) a mounting position (45) on the vehicle frame (12) of the vehicle (10) for a steering gear (160) or a steering column lever (156) of a hydraulic steering system (152); and
connecting (202), at the mounting position (45) or in the area of the mounting position (45), a second end area (40) of the first bell crank (38) in an articulated manner to the vehicle frame (12) of the vehicle (10) or to the steering actuator (46) wherein a point of application (63) of the steering actuator (46) on the steering linkage (37) lies spaced apart from the second end area (40) of the first bell crank (38).

15. The method according to claim 14 wherein the steering actuator (46) is connected (204) in an articulated manner in the longitudinal direction (13) of the vehicle frame (12) in the direction of a vehicle front side (67) in front of the mounting position (45).

16. The method according to claim 14 wherein the steering linkage (37) further comprises a coupling rod (74) and a second bell crank (76), the second bell crank (76) adapted in a first end area (77) of the second bell crank (76) or a central region (79) of the second bell crank (76) to be connected in an articulated manner to the vehicle frame (12) of the vehicle (10) or to the steering actuator (46), the second bell crank (76) connected in an articulated manner to a first end area (82) of the coupling rod (74) and the coupling rod (74) connected in an articulated manner in its second end area (88) to the first bell crank (38) and further comprising the step of connecting (204) the steering actuator (46) in an articulated manner by means of a sixth pivot joint (96) to the second bell crank (76) or the coupling rod (74),

17. The method according, to claim 14, further comprising the step of connecting (206) the steering actuator (46) in an articulated manner with a thud ball joint (57) to the steering rod (30).
